(19) United States
(12) Patent Application Publication
(10) Pub. No.: US 2009/0216635 A1
(43) Pub. Date: Aug. 27, 2009

(54) Business method and system for providing remuneration to consumers for viewing advertisements locally nationally and globally

(76) Inventor: Faheem Pasha, Albuquerque, NM (US)

Correspondence Address: FAHEEM PASHA, 2525 TINGLEY DR SW APT 120, ALBUQUERQUE, NM, 87104, US

(21) Appl. No.: 12/072,442

(22) Filed: Feb. 25, 2008

(51) Int. Cl. G06Q 30/00

(52) U.S. Cl. 705/14

(57) ABSTRACT

The present invention is a business method, operable and controllable by a computer, microcomputer or like electronic means, for the remuneration to consumers for viewing advertisements or like content over a global website. The website is designed to display a variety of promotional videos, audio or written advertisements and like content from advertisers who pay the website/business owner to have their content placed on the website. The advertisers can request a global display of their content or restrict viewing to specific areas, based on 4 postal codes. Consumers will earn money after they watch or read the advertisements and answer questions relevant to the advertisements. Consumers would accumulate money earned into an individual account registered by them, which when it reaches a predetermined dollar amount, can be requested through direct deposit into a bank account or can be redeemed for products or services offered by the advertisers.

### CROSS-REFERENCE TO RELATED APPLICATION

This application claims the benefit of US. Provisional Patent Application No. pending/applied for, Feb. 15, 2008.

### SUMMERY OF THE INVENTION

The present invention is a software business method, operable and controllable by a computer, microcomputer or like electronic means, for remuneration to consumers, and more particularly, to the remuneration to consumers for viewing advertisements or like content over a global computer network either locally (zip code restricted), nationally and globally. The advertising method for a website is a business method and system by which remuneration is provided to consumer for viewing advertisements. When plurality of registered users are getting paid to view or read the advertisement and take quizzes relevant to the advertisement. The website is designed to display plurality of promotional videos, audio or written advertisements and like contents from plurality of advertisers to plurality of consumers who would accumulate money by viewing plurality of advertisements and taking plurality of small quizzes; relevant to advertisements; consists of two or more questions. Advertisers would be paying to have their videos, audio, written advertisements and like contents displayed and consumers will be getting remunerated by viewing the advertisements and taking quizzes; accumulating set amount of money before withdrawing it via direct deposit; consumer will be redeeming cash via a direct deposit or making purchases of products offered by advertisers with accumulated cash and credit cards.

### BRIEF DESCRIPTION OF THE DRAWINGS

FIG. 1 is a screen shot of fully populated webpage in an advertising business method for website according to the present invention.

FIG. 2 is a screen shot of fully populated webpage in an advertising business method showing a flow chart that illustrate the functionality for both consumer and advertiser while advertisement is being shown locally (zip code restricted), nationally and globally; quizzes are being taken and cash is being accumulated by consumers, also shows the links to make purchases and move to other links leaving the webpage.

FIG. 3 illustrates the module of administration login and tasks administered by administration.

FIG. 4 illustrates the sequence of events that occurs when a consumer views an advertisement and competitor viewers concerning the present invention.

FIG. 5 illustrates the examples of advertiser's information and membership module concerning the present invention.

FIG. 6 illustrates the data base module regarding managerial tasks of advertiser concerning the present invention.

FIG. 7 illustrates a screen shot of consumer information concerning the present invention.

FIGS. 8, 9, 10 illustrate the accounting database of the present invention.

### BACKGROUND OF THE INVENTION

### Field of Invention

The present invention relates generally to a business method for remuneration to consumers, and more particularly, to the remuneration to consumers for viewing advertisements or like content over a global computer network, locally (zip code restricted), nationally and globally.

The novel features of the present invention will become apparent to those of skill in the art upon examination of the following detailed description of the preferred embodiment or can be learned by practice of the present invention. It should be understood, however, that the detailed description of the preferred embodiment and the specific examples presented, while indicating certain embodiments of the present invention, are provided for illustration purposes only because various changes and modifications within the spirit and scope of the invention will become apparent to those of skill in the art from the detailed description, drawings and claims that follow.

### DETAILED DESCRIPTION OF THE PREFERRED EMBODIMENT

Preferred embodiments of the present invention will hereafter be described in detail with reference to the accompanying Exhibits and drawings.

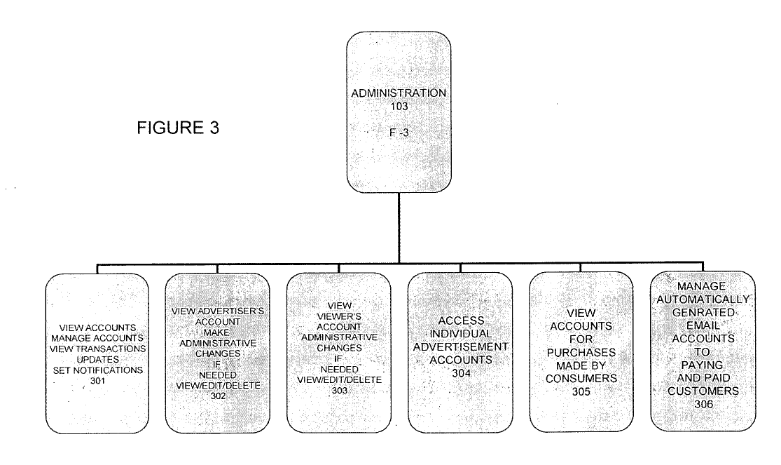

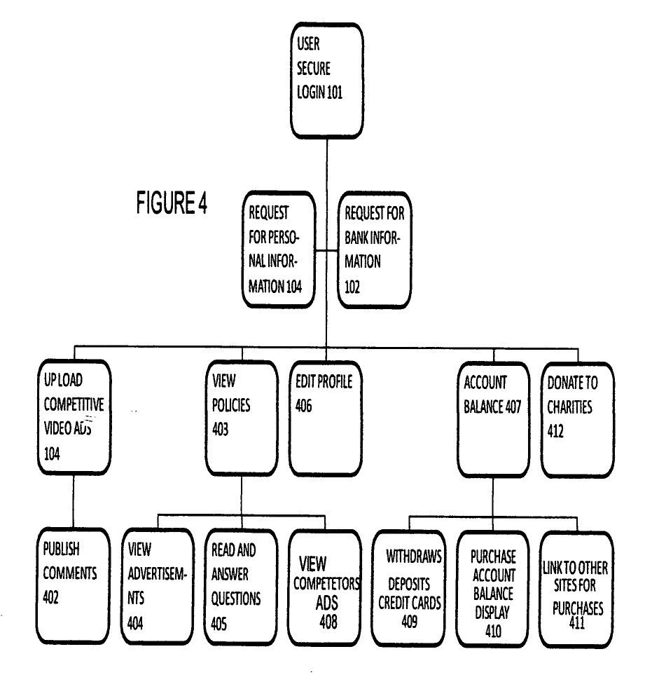

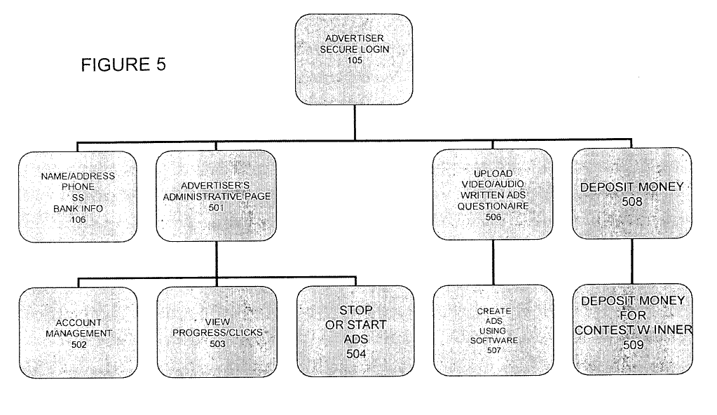

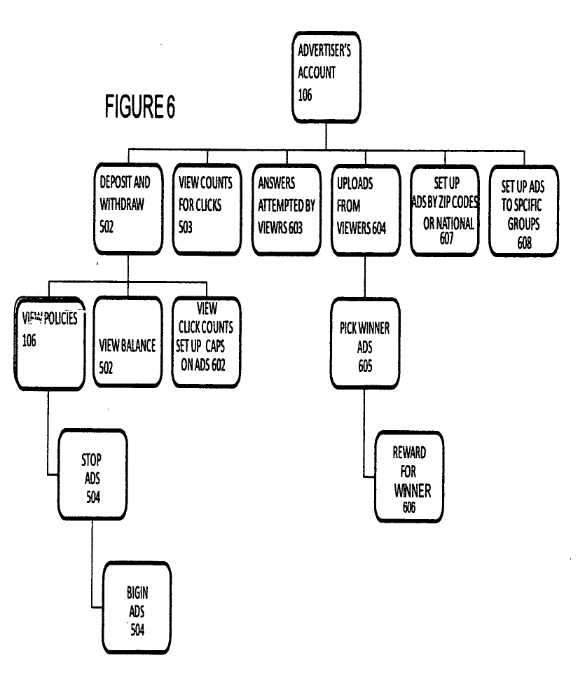

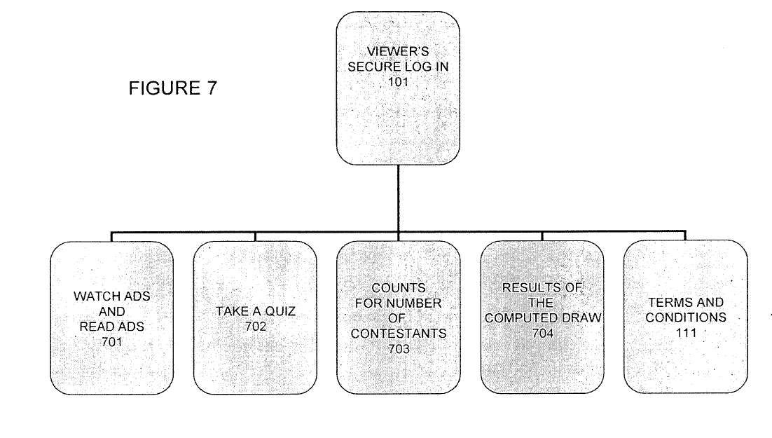

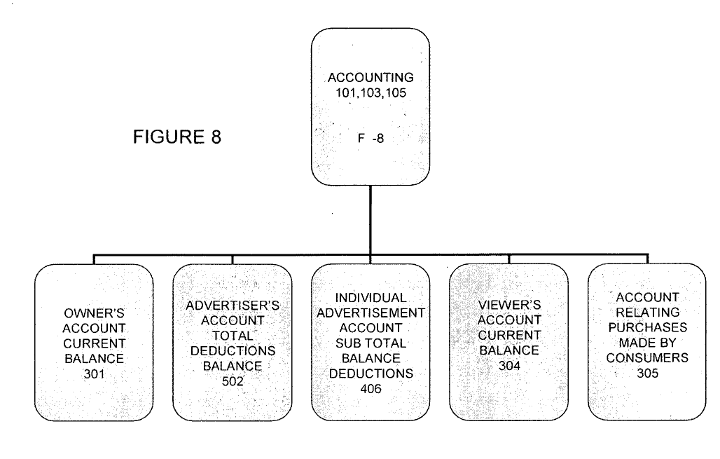

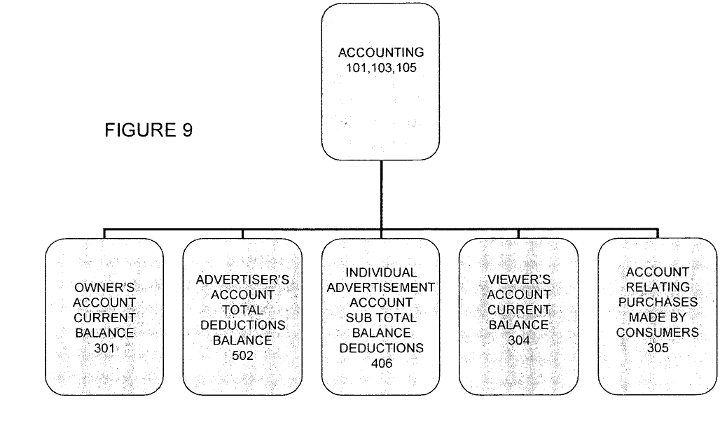

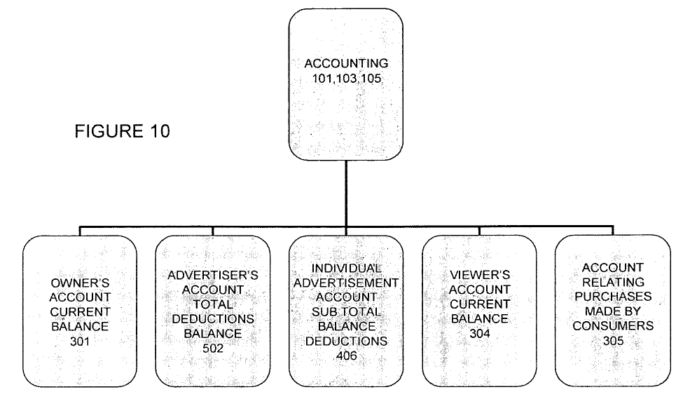

Those of skill in the art will realize that the attached drawings, while referencing Figure numbers can also be viewed by process steps corresponding to the Figure number (e.g., process step 506 refers to a step found in FIG. 5, process step 305 refers to a step found in FIG. 3, process step 406 found in FIG. 9 refers broadly to a process step found in FIG. 4).

The forgoing and other objects, aspects, and advantages will be better understood from the following non-limiting detailed description of preferred embodiments of the invention with reference to the drawings and flow charts that include the following:

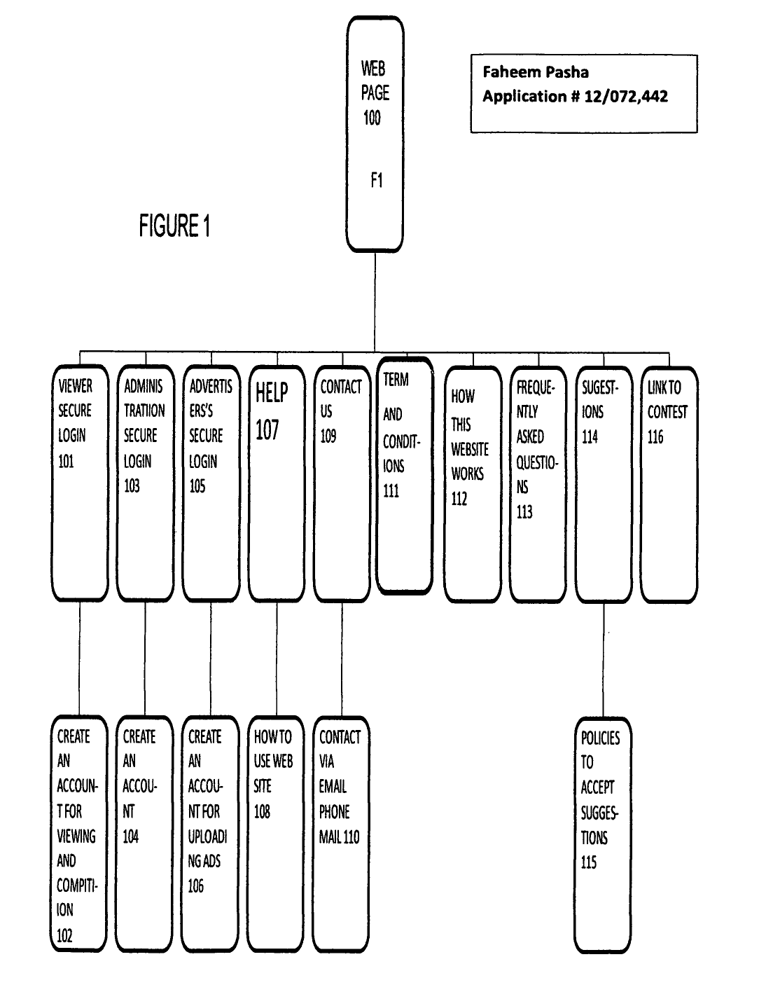

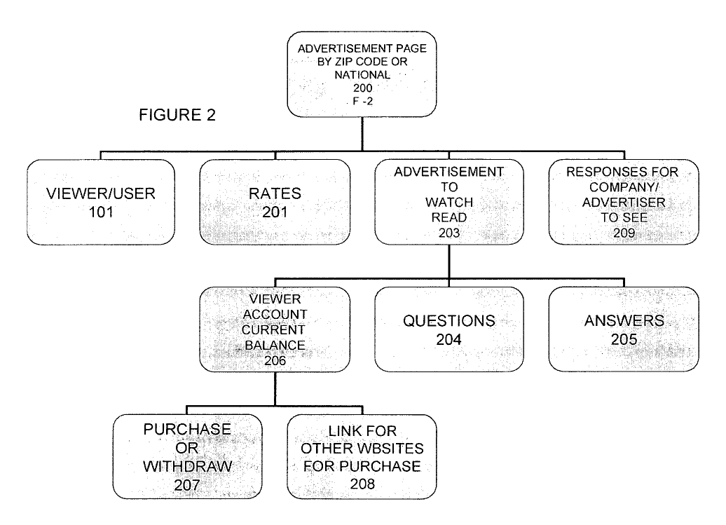

FIG. 1 is a representative flow chart of one preferred method or system (100), a flow chart describing all aspects of the website, including use and functionality. Illustrating software process steps to control, maintain and interact with multiple users, owner, advertiser, and viewer/consumer. (identified generally as step 101), 101 Users may setup an account or login using an already established account user login: the software to set up to receive an in put from the user providing the matching information (102) to that initially recorded as the base line information to let the user log in and utilize website (100). The computer software is adapted to (102) Users choosing to setup an account may do so here for website, it receives data from a user and create and save a base line information account, that is used every time a user tries to log in, for both regular viewing of videos (404) and/or to upload competitive advertisements (401), publish written comments (402) (101) there is also a link to (111) Terms and conditions apply, a page that consists of terms and conditions for consumer to read and electronically sign by clicking in a check box. (103) is a link that takes the data from user and process it to match with (104) the base line data provided by owner to (104). (104) is a software link to acquire data to set up base line information, so it can be matched when owner tries to log in, administrative login for website (103). (105) Advertisers may login for website or they may create a special type of account; is set up to receive an input by advertiser to match with (106) the initial base line data provided by advertiser so he/she could be able to use the website (100). (106) designed to accommodate uploads for website (100). 106 is a software link that records the data from advertiser to participate in competition page F-7 and/or F-5. (107) is a software link has stored information about how to use the website (100), and provides the link to (108) which has a visual aid to help understand the use of website (100). Software links (107) and (108) have visual data storage for any user to access it, without any requirement of login information. (107) a simple system designed to help users perform tasks within website (100). Also contained will be frequently asked questions. (109): Contact information will be provided for website (100), including email addresses, and direct feedback forms as well as phone number and physical corporate address. (109) is an interactive software set up to acquire, process the data enabling a user to write and email to owner and receive an reply from the owner. It also provide the phone numbers and mailing address for user (anybody) to communicate with owner and his staff, that is a contact us' feature. (111): Terms and conditions for administrative use of user data as well as any restrictions users and advertisers have on website (100). (111) is a software link with a stored, saved and unalterable form and shows policies and terms and conditions upon a process request/click for users (101),(103), (105) to read and understand, before they are ready to use website (100). (112): Visitors of website (100) will have the opportunity to see how easy it is to use website (100). This data will be presented through a flow chart diagram. Software link (107), (108), and (112) are interlinked and set up to receive an input/click from any user without requiring any base line login. (102), (104), (106) is information to provide the step by step visual of how to use the website (100). (113) is an interactive software link interlinked with (107), (108), (109), (110), (111), (112). (114) is an interactive software link that could accept an input from any user and send it to owner (103) but before sending the information to owner's (103) data base, it presents viewer with policies to accept suggestions page (115). (115) is software which stores the unalterable information about house policies to accept suggestions from any viewer. It can only be altered by owner (103). Upon viewer's request (click), the software (114) processes the data and before accepting data for suggestion it (114) presents the viewer page (115). Once accepted by viewer by clicking the check box, software (114) becomes interactive to process viewer's data and send it to owner (103).

In one preferred embodiment, the present invention is adapted to transmit an email communication to a user (101) (306) upon the on line availability of advertisement (203) to be viewed (404) by the viewer (101) or navigates the website (100) to request a page (200) to view an advertisement (203). (200) is an advertisement page, where advertisement is determined for being local (zip code restricted) or national or global and are uploaded (506) video or written advertisements (203) by the (105) advertiser, available for a viewer (101) to view (404), take quiz (405) regarding the product being advertised, and answer the questions (405). (201) is a software set up to disclose set dollar amounts credited for viewing (404) and taking quizzes (405) for each view. (203) is a media software set up to show advertisement (506) upon request. ((204) is a software that holds data for advertisements (203) uploaded (506) by advertiser (105) quizzes along with for viewer (101) to take and click at right answers(205) and then stores the answers in the data base which later can be seen (603) by advertiser (105). (206) is a software consisting of an automatic mathematical algorithm that shows a viewer (101) account accumulating the dollar amount as it accumulates each time the viewer (101) views an advertisement (203). Software is inter-linked with software (205). Once the viewer (101) complete clicking on all right answers (205), software (206) automatically ads the earned amount into viewer's (101) account, which is visible to viewer (101) in real time. (207) is software set up to use dollar amounts earned (206) to make purchases (207) by going to an other interlinked software connections (208) which takes viewers (101) to another site that offers products for sale. (207) is also set up with Automated Clearing House to enable viewer (101) to withdraw the (only/earned) balance amount showing in his/her account. Viewer (101) can either make a purchase (207) or initiate a withdraw (207).

An owner (103) can request an access to software (301). (301) is a software set up to link with viewer's account software (101) and software (115), house policies regarding accepting suggestions. (302) is a software set up to provide information regarding advertiser's (105) account to owner (103) upon owner's request. Owner (103) can make changes like view/edit/delete as software (302) allows owner (103) to do so. (303) software takes instructions from owner (103) to process tasks such as view/delete/edit the viewer's (101) account. (304) is a software link that is connected with an advertiser (203) as an individual account and its viewers (101) and with a mathematical algorithm that show live deductions in advertiser's balance (502) as it is happens. The owner (103) can view the purchases made by customers (101) with their account balance by using software link (305). (305) is a software link that holds and stores the data input using mathematical algorithm for purchases (410) made by consumer (101) and shows it to the owner (103) upon request. (306) is software that automatically generates emails to members (101) and advertisers (105), when an advertisement (203) ready to be released by owner (103). Owner (103) initiates (306) emails when he is ready to release an advertisement to the public (101). Owner (103) releases advertisements (203) once he receives information from advertisers' account (502) that money has been deposited to owner's account (301).

A consumer/viewer (101) logs in (102) if they have created an account (102) for this webpage (100), navigates the webpage (100) and can decide to perform different tasks, one of which can be to upload ads (401), create an alternate version (203) and upload it (401). If the consumer (101) does not have the ability to make a video, they can write in comments and upload them (402) on the website (100). Before a consumer can upload (401), (402) an ad or comment they have to read the house policies (403) and agree on terms and conditions set by the owner (103). Another task a viewer (101) can perform by using a software link (404) is to view ads already released by owner (103), take quizzes about the ad (405) up to a limited number of times, and see their money accumulating (407),(410) in a side pane of the webpage (100). Consumer (101) can than manage their account (406) and edit their profile and other necessary information to keep the consumer's (101) account updated. Viewer (101) can also set up an automatic withdrawal of their money that is showing in the balance (407), (410) when it reaches a minimum amount. Viewer (101) can also donate their money to charity by using the link (412) and if they decide to add more money by a credit card (409), they can do so by using the software link (409). (412) is a software link that provides links to charity websites. (411) is a software link that stores links from the Advertiser's (105) websites. These websites offer their products to the viewers (101). The (411) and (306) are interconnected for owner (103) to keep track of the purchases made (410) by consumers (101), so owner can collect a percentage from advertisers (105).

Through step (105), advertisers have their own page where they can login(106) by creating a profile that is composed of company and banking information,so money can be deposited/withdrawn to and from the site (100) and owner's account (103). (501) is a software link set up to receive information from the advertiser (105) and match it with the profile already stored in software link (106). Once the information/password and user name are matched, the advertiser (105) is given administrative authority to manage their own account (502). (502) is a software link that is set up to provide the advertiser (105) links to (503) and (504). (503) is a link that shows the number of viewers/clicks (101) that have been watching (404) and taking quizzes (405). If at any point and advertiser (105) wants to stop his advertisements from being shown (504), they can use the link (504) to do so. They can also use the link (507) if they want to edit their ads. (508) is a software link set up to deposit money (508) by using ACH (automatic clearing house) or other transfer method to owner's (103) account. An advertiser (105) can use the same link (508) to withdraw the money shown in their advertising account balance (304). (509) is a software link set up to store and keep the money transactions only for only the winners (101) who participate in a contest (401), (402).

(501) (502) is a software link that allows advertisers (105) to perform administrative tasks, such as deposit and withdraw money (508), view click counts (503), view quizzes taken by viewers (603), view other uploaded advertisements (401), (402) by using software link (604) and then pick the winner and store the winner's (105) name and comments in software link (605) for everyone (101) to see (704). Viewers (101) can also see other contestants' ads under software link (703). (606) is a software link that receives and keeps the data regarding viewers (101) who win the contests and also allow advertisers (105), or owner (103) to deposit reward money directly to that viewer's (101) account. (607) is a software link that stores the zip code information for the whole country and allows an advertiser (105) and owner (103) to release an advertisement to be available for only viewers in specified zip codes. Link (607) also provides the option for advertisers to release for al zip codes nationally.

Software link (116) will direct the viewer (101) to (102) to login and allow them to watch other contestants' ads (701), and see the number of contestants participating (703), in real time by a mathematical algorithm. Viewers (101) can also see whose advertisement got the prize by clicking on software link (704). (704) is a software link where owner (103) or advertiser (105) can post information e.g., name and picture of the viewer (101) who wins the contest and also the amount won. In that regard software link (606) and software link (704) and software links (302), (303), (304) are interlinked.

Software link (116) is adapted to take owner (103) to software link (301) this gives access to owner (103) of advertiser's account (502) to see their current balance and history of the account. Software link (301) also gives access to owner (103) of viewer's (101) account (406) to see their account history, balances, purchases, withdrawals and profile. Software link (116) also gives access to owner (103) to see an individual advertiser's account and its progress as it is being viewed by viewers (101), payments and deductions being happening in real time, account sub totals, and balance (304) by the use of a mathematical algorithm. Software link (116) also gives owner (103) access to software link (305). (305) is software link that keeps record of viewer's (101) purchases by using a mathematical algorithm.

As will be appreciated by one of ordinary skill in the art, the present invention may be implemented as a method, a process, a data processing system, a software system, a firmware system, a hardware system, and/or a computer program product or a combination thereof. Accordingly, the present invention may take the form of an entirely software embodiment, an entirely hardware embodiment, or an embodiment combining aspects of both software and hardware. Additionally, in the foregoing specification, the invention has been described with reference to specific embodiments. However, it will be appreciated that various modifications and changes can be made without departing from the scope of the present invention as set forth in the claims below. The specification and figures are to be regarded in an illustrative manner, rather than a restrictive one, and all such modifications are intended to be included within the scope of present invention. Accordingly, the scope of the invention should be determined by the appended claims and their legal equivalents, rather than by the examples given above. For example, the steps recited in any of the method or process claims may be executed in any order and are not limited to the order presented in the claims when the claims are presented for review.

The foregoing description of the preferred embodiments of the invention has been presented for the purposes of illustration and description. Other variations and modifications of the present invention will be apparent to those of ordinary skill in the art, and is not limited except by the appended claims. The particular values and configurations discussed above can be varied, and are cited to illustrate particular embodiments of the present invention. As such, for example, any of the data networking communication methods disclosed may be implemented through either encrypted or secure modes. It is contemplated that the use of the present invention can involve components having different characteristics as long as the principles disclosed herein are followed.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as critical, required, or essential features or elements of any or all the claims. As used herein, the terms “comprises”, “comprising”, or any other variation thereof, are intended to cover a non-exclusive inclusion, such that a process, system, method, article, or apparatus that comprises a list of elements does not include only those elements but may include other elements not expressly listed or inherent to such process, system, method, article, or apparatus. Further, no element described herein is required for the practice of the invention unless expressly described as “essential” or “critical”.

Other variations and modifications of the present invention will be apparent to those of ordinary skill in the art, and it is the intent of the appended claims that such variations and modifications be covered. The particular values and configurations discussed above can be varied, are cited to illustrate representative embodiments of the present invention and are not intended to limit the scope of the invention. It is contemplated that the use of the present invention can involve components having different characteristics as long as the principle is followed.

1- A computer implemented business method and system for an advertising website, according to claim 1, comprising promotional videos, audios, cartoon images, written advertisements and like contents from plurality of advertisers on a plurality of web pages. Registered advertisers would have administrative control to upload their advertisements on the website for viewing locally (postal code restricted), nationally, or globally.

2- A computer implemented business method and system for an advertising website, according to claim 2, wherein the advertisers will receive a specified number of visits to their advertisements in exchange for a specified payment amount to the website/business owner. After there have been this specified number of visits to the advertisements, the advertiser would be required to make further direct electronic payment to the website/business owner, in order to continue.

3- A computer implemented business method and system for an advertising website, according to claim 3, further comprising the step of providing an opportunity for viewers/consumers of the advertisements to be remunerated after viewing advertisements and answering a few short questions related to the advertisements.

4- A computer implemented business method and system for an advertising website, according to claim 4, whereby the viewer/consumer's remuneration will be deposited into an account created by the viewer/consumer when they register on the website, which would be accessible by individual login. Upon accumulation of a predetermined dollar amount into their account, the viewer/consumer can request payment by electronic transfer into a bank account, redeem their balances for products or services offered on the website by the advertisers, or donate to a selection of charities.

5- A computer implemented business method and system for an advertising website, according to claim 5, further comprising the step of creating a link for viewers/consumers to use credit cards for purchasing products or services from the advertising merchants.

6- A computer implemented business method and system for an advertising website, according to claim 6, further comprising the step of predetermining number of times a viewer/consumer can watch a specific advertisement for remuneration, within a specified time frame.

7- A computer implemented business method and system for an advertising website, according to claim 7, further comprising the step of the advertisers periodically offering a contest to the viewers/consumers whereby viewers/consumers would create an advertisement and upload it to the website. The advertisers would determine winners and award cash prizes to the viewers/consumers.

8- A computer implemented business method and system for an advertising website, according to claim 8, further comprising the step of an option for viewers/consumers to enter a drawing for a cash prize. Winners would be randomly selected, using an algorithm, from among the plurality of viewers/consumers who view advertisements and answer the associated questions.
